(19) United States
(12) Patent Application Publication
(10) Pub. No.: US 2015/0095776 A1
(43) Pub. Date: Apr. 2, 2015

(54) VIRTUAL MANIFESTATION OF A NAS OR OTHER DEVICES AND USER INTERACTION THEREWITH

(71) Applicant: Western Digital Technologies, Inc., Irvine, CA (US)

(72) Inventors: MICHAEL F. EGAN, MOUNTAIN VIEW, CA (US); OFIR LEVY, PALO ALTO, CA (US)

(73) Assignee: Western Digital Technologies, Inc., Irvine, CA (US)

(21) Appl. No.: 14/099,689

(22) Filed: Dec. 6, 2013

Related U.S. Application Data
(60) Provisional application No. 61/885,437, filed on Oct. 1, 2013.

(51) Int. Cl. H04L 12/26; H04L 29/08; H04L 29/06; G06F 3/0484

(52) U.S. Cl. CPC H04L 43/045; G06F 3/0484; H04L 67/1097; H04L 65/60
USPC 715/716; 715/736

(57) ABSTRACT

A device may comprise a display interface and a processor coupled to the display interface. The processor may be configured to couple to a remote network-connected device over a computer network; generate a graphic representation of the network-connected device on the display and send the generated graphic representation to the display interface. A status of the network-connected device may then be received over the computer network and cause, responsive to receiving the status of the network-connected device, the graphic representation of the network-connected device to change appearance depending upon the received state the network-connected device.

### CROSS-REFERENCE TO RELATED APPLICATIONS

This application claims benefit of U.S. Provisional Patent Application Ser. No. 61/885,437 entitled “VIRTUAL MANIFESTATION OF A NAS OR OTHER DEVICES AND USER INTERACTION THEREWITH,” filed Oct. 1, 2013, the disclosure of which is incorporated by reference herein in its entirety.

### BACKGROUND

Network Attached Storage (NAS) is not an accessible technology for the average user. Even sophisticated users are not fully aware of what NASs do or how they work. Moreover, with increased reliance on the availability of network-connected devices, the average user is often unaware of the current status and available remote functionality of their network-connected devices.

### BRIEF DESCRIPTION OF THE DRAWINGS

FIG. 1 is a diagram illustrating aspects of one embodiment.

FIG. 2 shows a graphic representation of a network-connected device in a media player configuration and of a mobile device displaying the same, according to one embodiment.

FIG. 3 shows a graphic representation of a network-connected device, configured with a pull-out tab, according to one embodiment.

FIG. 4 is a diagram illustrating file management functionality of a graphic representation of the network-connected device, according to one embodiment.

FIG. 5 is a diagram of a graphic representation of the network-connected device and of a computing device displaying the same, according to one embodiment.

FIG. 6 is a diagram of a graphic representation of the network-connected device generating a solicited or unsolicited notification upon receipt of the state the network-connected device, according to one embodiment.

FIG. 7 is a diagram of a graphic representation of the network-connected device that is configured to generate a user interface, according to one embodiment.

FIG. 8 is a flowchart of a method according to one embodiment.

FIG. 9 shows a network in which embodiments may be practiced.

### DETAILED DESCRIPTION

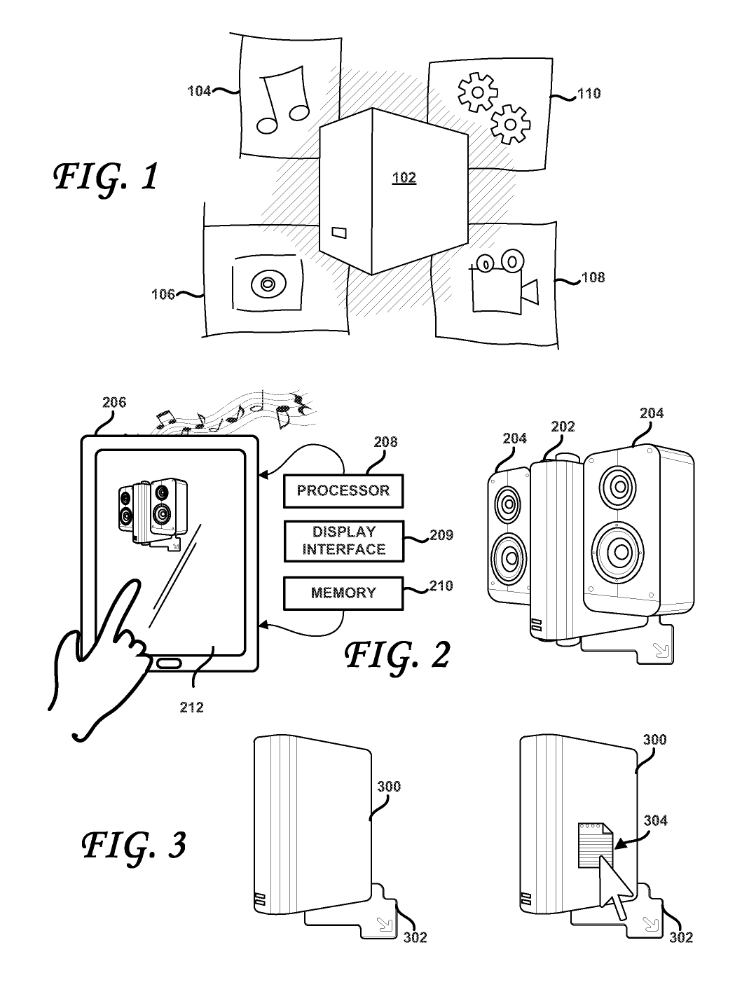

As suggested by FIG. 1, an embodiment helps users visualize the operation and function of network-connected devices such as, for example, NASs. According to one embodiment, a desktop graphic representation 102 (rendered on the desktop of the user's computing device, for example) provides an intuitive and interactive visual representation of a network-connected device, its health, available functionality and its operation. According to one embodiment, the graphic representation 102 (in one implementation, a widget or an animated and/or interactive icon) may constitute a visual anchor to the network-connected device that it graphically represents. The graphic representation 102 of the network-connected device itself, according to one embodiment may not change. Alternatively, a portion thereof may not change. However, such graphic or visual representation of the network-connected device may be supplemented or otherwise provided, according to one embodiment, with additional context and operationally-sensitive graphics 104, 106, 108, 110 that may be configured to inform the user of the health, functionality and/or operation of the network-connected device and/or to enable the user to interact therewith. For example, as shown in FIG. 1, such additional graphics may be configured to inform the user that the device is streaming music, as suggested at 104, serving photographs to the user's device, as suggested at 106 or streaming video content, as suggested at 108. Additional graphics may also be provided, as shown at 110, to enable the user to view and/or modify the settings of the network-connected device and/or of the graphics themselves.

The device, such as a NAS, may be coupled to the user's local computing device. Alternatively, the network-connected device may be remote from the user's current location and only accessible via a network connection. In that case, the graphic representation of the network-connected device on a user's display is of a network-connected device that is remote from the user and remote from the device on which the graphic representation is displayed. Within the present context, a remote network-connected device comprises, within its scope, devices that are coupled to a computer network such as the Internet, other Wide Area Network (WAN) or coupled to a Local Area Network (LAN) and that may not be directly coupled to the user's computing device.

According to one embodiment, there may be one such graphic representation of the network-connected device per network-connected device, with each graphic representation (e.g., icon, widget) having multiple functional and visual aspects, as described and shown herein. Each of these functional and visual aspects may be based upon the graphic representation of the network-connected device, such that the anchor to the network-connected device is maintained. Stated differently, a portion of the graphic representation of the network-connected device may be static or be maintained as a recognizable entity associated with the graphic representation of the network-connected device. For example, in FIG. 2, the anchor to the network-connected device is shown at 202. For example, 202 may comprise a NAS. The functional aspects may be added, emerge from or may be otherwise incorporated into the graphic representation of the network-connected device, to intuitively communicate some functional or operational aspect of the graphic representation of the network-connected device, without obscuring or otherwise unrecognizably changing the characteristic features of the graphic representation that the user associates with a specific network-connected device. As shown in FIG. 2, when the network-connected device is streaming music, speakers 204 may be seen to emerge from the NAS 202 on either side thereof without obscuring or otherwise unrecognizably altering the appearance of the graphical representation of the, in this case, NAS device 202. As shown, such graphic representation of a network-connected device may be generated, sent to a display interface and ultimately rendered on a display of a computing device, such as mobile device 206, also shown in FIG. 2. The computing device 206 may comprise, as is known, a processor 208, a display interface 209 and memory 210. The computing device may (but need not) comprise a display 212 in communication with the display interface 209.

The graphic representation of the network-connected device, according to one embodiment, operates not only to provide the user with solicited or unsolicited information, but may also be configured to accept commands from the user or otherwise engage in simple or more complex interactions with the user. For example, the graphic representation of the network-connected device may respond to user queries and/or commands and may provide information regarding the graphic representation of the network-connected device on-demand. For example, the graphic representation of the network-connected device 300 may be provided with a tray or pull-out tab 302, as shown in FIG. 3. Pulling out the tray or pull-out tab 302 (e.g., with a pointer, finger, voice or gesture) may reveal more a more complex UI, enabling further interactions with the network-connected device 300. According to one embodiment, the tray or pull-out tab 302 may be collapsible. For example, the tray or pull-out tab 302 may be configured to collapse when not in use to, for example, a thin line next to the graphic representation of the network-connected device. This line may only be visible when the user's cursor comes near the graphic representation of the network-connected device. The user may then select the thin line or otherwise make a selection that causes the tray or pull out tab to become visible and/or open again. Simple interactions, such as storing a document 304 in the network-connected device 300, may be carried out by simply dragging and dropping the document onto the network-connected device, as also shown at 304 in FIG. 3.

Comprehensive file management features may be accessible via the graphic representation of the network-connected device, as suggested in FIG. 4. Such file management features may include, for example, the creation, deletion and updating of files and directories, changing directory structures, opening, closing, copying and moving files and directories, for example.

The graphic representation of the network-connected device, therefore, may comprise a graphic that provides context and operational or functional clues as to the (e.g., current) state, operation and/or health of the network connected device, such as a NAS or other functionally-dedicated (e.g. media streaming) device. The graphic representation of the network-connected device, according to one embodiment, allows for quick, direct and intuitive user interaction with the network-connected device, even when operating over the WAN.

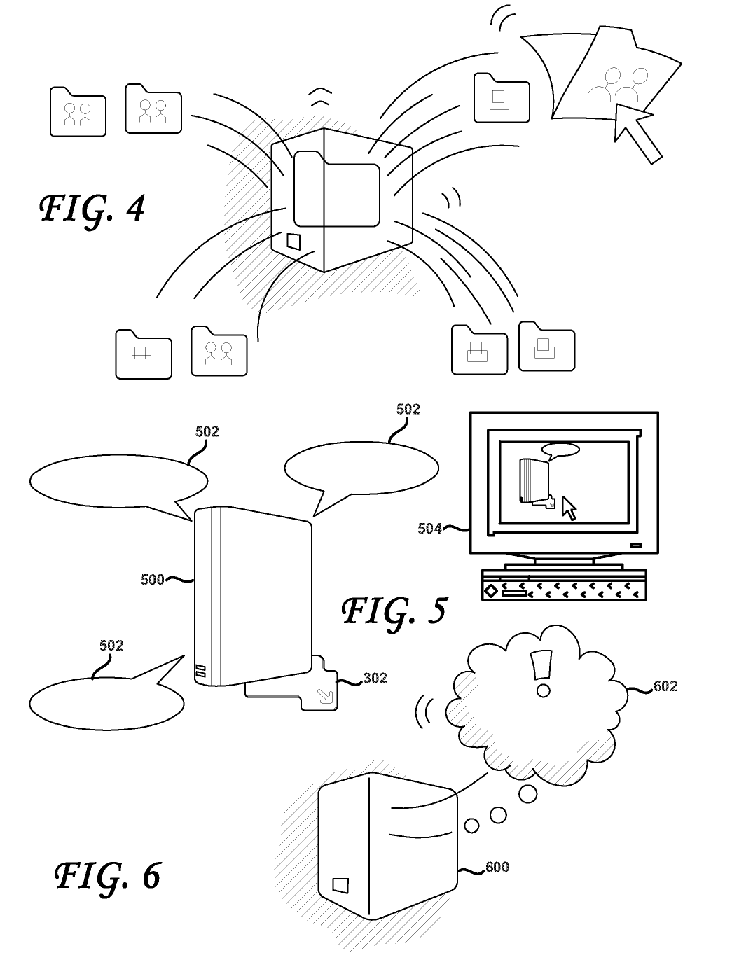

According to one embodiment, the graphic representation of the network-connected device may be configured to exhibit behaviors and animations. After the interaction, or after the state, behavior or action of the graphic representation of the network-connected device having given rise to the animation or other change in appearance or behavior has taken place, the graphic representation of the network-connected device may return to an initial, default or quiescent state. Indeed, according to one embodiment, the graphic representation of the network-connected device may return to an initial default state when not in active use. The graphic representation of the network-connected device 500 may, therefore, exhibit behaviors, may generate communications as shown at 502 in FIG. 5 and/or may change in appearance in intuitive manners that convey a limited number of characteristics, behaviors or functionalities at a time. The communications 502 may be textual, graphic, visual and/or auditory in nature. The computing device on which the graphic representation of the network-connected device is rendered may be, for example, a personal computer (PC) 504 or equivalent computing device configured to access a computer network. The communication to the user may take most any form, as illustrated by the message bubble 602 emerging from the graphic representation of the network-connected device 600 in FIG. 6.

The graphic representation of the network-connected device may display a single behavior or animation conveying a single message at any given time, at least for a given user. According to one embodiment, in the case wherein the network-connected device (such as a NAS) is streaming video to a first person and storing files for a second person, the graphic representation of the single network-connected device may be simultaneously different and contextually relevant for each of the two users. In this case, for example, the graphic representation of the network-connected device may further comprise graphics suggestive of a movie theater for the first user and graphics suggestive of a simple file manager user interface (UI) for the second user.

According to one embodiment, the graphic representation of the network-connected device may have a different appearance depending upon the actions of the user. For example, the appearance of the graphic representation of the network-connected device may be different (e.g., provided with engaging animation) when the user plays music from the network-connected device associated with the graphic representation of the network-connected device. Similarly, the appearance of the graphic representation of the network-connected device (in this example, a NAS) may be different when the user stores files on a drive or moves files from one to another, when the user mounts a WebDAV folder as a shortcut, drive letter or device (for Mac). The appearance thereof may also dynamically change when the user wants to, for example, see how much space is available on the drive. This is an example of a user-driven status request. Also, the appearance of the graphic representation of the network-connected device may be different when the drive is nearly full, full or failing. Such a warning message may be communicated, for example, in the manner shown at 602 in FIG. 6. This is an example of the graphic representation of the network-connected device exhibiting an unsolicited device status.

The appearance of the graphic representation of the network-connected device may change when the user simply requests the status of the network-connected device, which is an example of a solicited status update. For example, when a user selects the status aspect of the graphic representation of the network-connected device (requests a status of the network-connected device), the graphic representation of the network-connected device may show one or more visible representations of a few select pieces of information the user cares about the most such as, for example:
The space available on the drive (e.g., bar or pie chart or other graphical or alphanumerical representation);
The load on the drive; and/or
Drive connectivity.

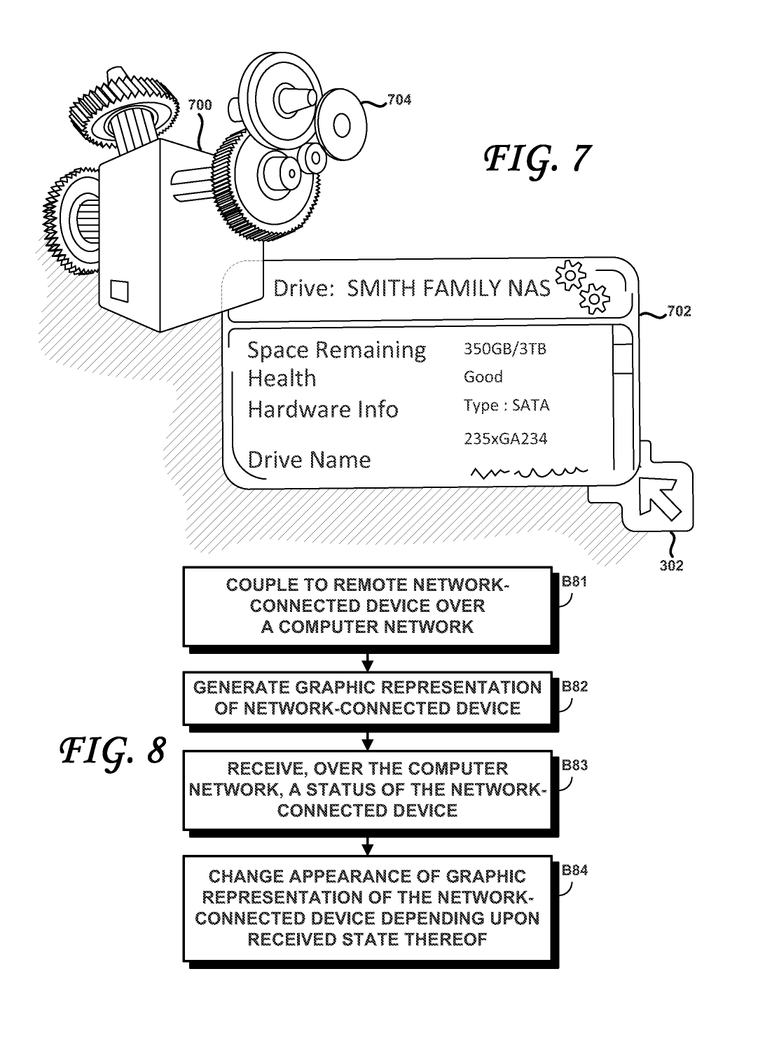

Such is shown in FIG. 7, which illustrates the case in which the user has selected or pulled out the pull-out tab 302 and requested the status of the network-connected device associated with the graphic representation of the network-connected device 700. For example, after the user has pulled out the pull-out tab or tray 302 and selected device status or device information, a request for such status or information may be generated and sent through the computer network (comprising, for example, the Internet) to the remote network-connected device. The network-connected device may then reply to the requested status query, send the requested information through the computer network, which information may then be received by the user's computing device, the processor of which then causing the graphic representation of the network-connected device to generate additional graphics comprising the requested status. These additional graphics 702 emerging from the graphic representation of the network-connected device may then communicate the solicited information to the user without, however, obscuring or otherwise unrecognizably altering the appearance of the graphic representation of the network-connected device 700. In addition, engaging graphics that intuitively indicate to the user that his or her request is being processed may be generated and caused to emerge from the graphic representation of the network-connected device, as shown at 704. These graphics 704 may be animated (i.e., gears may turn, for example) to further reinforce the impression that the device is working to fulfill the user's request. Once the pull-out tab or tray 302 is pushed back into the graphic representation of the network-connected device 700, the additional graphics comprising the requested information 702, as well as the animated graphics 704 may dynamically collapse or be re-absorbed within the graphic representation of the network-connected device 700, to return the graphic representation of the network-connected device 700 to its initial, default or quiescent state.

According to one embodiment, the behavior of the graphic representation of the network-connected device may be different on rollover than it is when the graphic representation of the network-connected device is selected by the user's pointer or other interaction modality. For example the graphic representation of the network-connected device may be configured such that on rollover, the graphic representation of the network-connected device provides the user with the above status in a blown up view with clear unabbreviated text in large fonts.

According to embodiments, the graphic representation of the network-connected device may be configured to provide the user with other visually engaging status indicators. Exemplary among these may be:
a bandage on drive if the Self-Monitoring, Analysis and Reporting Technology (S.M.A.R.T.) status fails (in the case wherein the graphic representation of the network-connected device is a storage device such as a NAS);
a pulsating desaturation when the graphic representation of the network-connected device has no or has just lost network connectivity; and/or
text balloons for actual status messages.

As those of skill in this art may recognize, a great many functionalities may be mapped to and enabled by the graphic representation of the network-connected device according to embodiments. Such functionalities may including, for example:
Password memorization, access without login;
Status channel (flashing, shaking, speech balloons, etc.);
Immediate connection between status and device (ex: clicking a speech balloon may call up a UI or help reference specific to the problem);
Ability to provide unsolicited status;
Engaging visuals;
The graphic representation of the network-connected device becoming animated as music is played;
Speech balloons, shaking and the like for status indication;
Seasonal or day/night decoration;
Visual representation of attached (e.g., USB) devices;
Readily available functionality (via direct manipulation);
Drag files onto widget to copy or move;
Control-drag folder to sync;
Drag another widget to this widget to do NAS to NAS sync;
Standard context menu or ROP for more functionality;
Play video straight to desktop;
Direct WebDAV access with no keystrokes or drive letter;
Easy access to the main UI;
Easy access to attached USB devices
Functionality and appearance may be consistent across platforms (e.g., PC, Mac, Android, iOS and the like);
Each device can have features specific to the device while tied together in a common Look & Fee (L & F); and/or
   Auto discovery of new devices coupled to the network by generating a new graphic representation thereof on the user's desktop.

As shown in FIG. 8, one embodiment is a method. The method may comprise, as shown at B81, coupling to a remote network-connected device over a computer network or discovering the same. A graphic representation of the network-connected device may then be generated, as shown at block B82. The status of the network-connected device may then be received, over the computer network, as called for by B83. Lastly, as shown at B84, the graphic representation of the network-connected device may be caused to change appearance depending upon the received state the network-connected device responsive to, for example, receiving the status of the network-connected device.

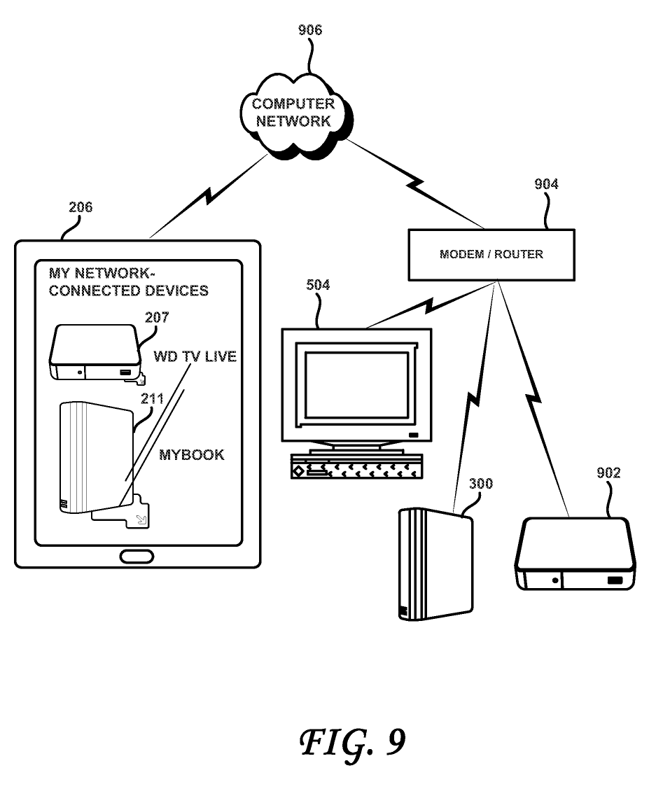

As shown in FIG. 9, a computing device 206 (e.g., a mobile computing device such as a mobile phone or tablet) may run a browser an app or an applet (for example) in which graphic representations of the user's network-connected devices may be displayed. As shown on the display of computing device 206, a graphic representation 207 of the user's network-connected device media player 902 (such as, for example, Western Digital's WD TV Live network-connected device) is shown, as is a graphic representation 211 of the user's NAS 300. As shown, the user's NAS 300 and the user's media player 902 may be coupled to the computer network 906 through a modem and/or a router, as shown at 904. Embodiments enable the user to be apprised of the current status of his or her network-connected devices 300, 902 and interact with such devices through the graphic representations of the network-connected devices, in the manners described above and equivalents thereof. Significantly, real-time or near real-time statuses (both solicited and unsolicited) of one or more remote network-connected devices may be communicated to the user over a computer network through graphic representations of his or her network-connected devices. Moreover, embodiments enable users to control and/or otherwise interact with and issue commands to their network-connected devices through corresponding graphic representations thereof, according to embodiments.

According to further embodiments, the received status of the network-connected device may be unsolicited and/or initiated by the network-connected device. Alternatively, the received status of the network-connected device may have been solicited over the computer network. Causing the graphic representation of the network-connected device to change appearance may comprise changing the appearance of the graphic representation of the network-connected device such that a portion (e.g., the anchor portion) thereof remains unchanged. One or more user interactions with the graphic representation of the network-connected device may be detected. The change in the appearance of the graphic representation of the network-connected device may then be responsive to the detected user interaction. The network-connected device may comprise storage such as, for example, a NAS. For example, the network-connected device may also be configured to stream media over the computer network. The change in the appearance may comprise additional graphics that, for example, emerge from or appear alongside the graphic representation of the network-connected device. Such change in the appearance, according to one embodiment, may comprise additional graphics that form a user interface that emerges from or otherwise appear in association with the graphic representation of the network-connected device. The change in the appearance may comprise additional graphics that are suggestive of the received state the network-connected device. The graphic representation of the network-connected device may comprise, for example, a pull-out tab configured to enable a command to be initiated and sent to the network-connected device. The state of the graphic representation of the network-connected device may comprise, show or otherwise communicate the current operation(s) carried out and/or functions discharged by the network-connected device.

According to one embodiment, actions may be initiated through user-manipulation of graphic representations of network-connected devices. For example, a first graphic representation of a network-connected device may be caused to initiate and carry out some action or command, upon being dragged upon or otherwise associated, by the user or programmatically, with a second graphic representation of a network-connected device. For example, a first graphic representation of a network-connected device may be caused to, for example, sync with a second graphic representation of a network-connected device through the user dragging one on top of the other or otherwise manipulating the first and/or second graphic representation(s) in a predetermined manner. For example, a graphic representation of a network-connected storage device may be dragged or manipulated onto or adjacent to a graphic representation of a network-connected media rendering device, to thereby cause the associated media rendering device to update its library with media stored on the associated storage device. Other actions and interactions by and between network-connected devices may be initiated through manipulation of the graphic representations thereof and all such actions and interactions are expressly included within the scope of the present description.

While certain embodiments of the disclosure have been described, these embodiments have been presented by way of example only, and are not intended to limit the scope of the disclosure. Indeed, the novel methods, devices and systems described herein may be embodied in a variety of other forms including, for example, sequences of computer-readable instructions stored on tangible, non-transitory storage media. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure.

What is claimed is:

1. A device, comprising:
a display interface; and
a processor coupled to the display interface, the processor being configured to:
communicate with a remote network-connected device over a computer network;
generate a graphic representation of the network-connected device and send the generated graphic representation of the network-connected device to the display interface;
receive, over the computer network, a status of the network-connected device; and
cause, responsive to receiving the status of the network-connected device, the graphic representation of the network-connected device to change appearance depending upon the received state the network-connected device.

2. The device of claim 1, wherein the received status of the network-connected device is unsolicited.

3. The device of claim 1, wherein the received status of the network-connected device is initiated by the network-connected device.

4. The device of claim 1, wherein the received status of the network-connected device is solicited over the computer network.

5. The device of claim 1, wherein the processor is further configured to change the appearance of the graphic representation of the network-connected device such that a portion thereof remains unchanged.

6. The device of claim 1, wherein the processor is further configured to:
detect a user interaction with the graphic representation of the network-connected device; and
change in the appearance of the graphic representation of the network-connected device responsive to the detected user interaction.

7. The device of claim 1, wherein the network-connected device comprises a Network Attached Storage (NAS).

8. The device of claim 1, wherein the network-connected device is configured to stream media over the computer network.

9. The device of claim 1, wherein the processor is further configured to generate additional graphics that emerge from the graphic representation of the network-connected device.

10. The device of claim 1, wherein the processor is further configured to generate additional graphics to form a user interface that emerges from the graphic representation of the network-connected device.

11. The device of claim 1, wherein the processor is further configured to generate additional graphics that are suggestive of the received state the network-connected device.

12. The device of claim 1, wherein the processor is further configured to generate a pull-out tab that emerges from the graphic representation of the network-connected device to enable a command to be initiated and sent to the network-connected device.

13. The device of claim 1, wherein the state of the graphic representation of the network-connected device comprises a current operation carried out by the network-connected device.

14. The device of claim 1, wherein the processor is further configured to enable the generated graphic representation of the network-connected device to interact with another graphic representation of a network-connected device to carry out a function.

15. A method, comprising:
communicating with a remote network-connected device over a computer network;
generating a graphic representation of the network-connected device;
receiving, over the computer network, a status of the network-connected device; and
causing, responsive to receiving the status of the network-connected device, the graphic representation of the network-connected device to change appearance depending upon the received state the network-connected device.

16. The method of claim 15, wherein the received status of the network-connected device is unsolicited.

17. The method of claim 15, wherein the received status of the network-connected device is initiated by the network-connected device.

18. The method of claim 15, wherein the received status of the network-connected device is solicited over the computer network.

19. The method of claim 15, further comprising detecting a user interaction with the graphic representation of the network-connected device and wherein the change in the appearance of the graphic representation of the network-connected device is responsive to the detected user interaction.

20. The method of claim 15, wherein the network-connected device comprises a Network Attached Storage (NAS).

21. The method of claim 15, wherein the change in the appearance comprises additional graphics that emerge from the graphic representation of the network-connected device.

22. The method of claim 15, wherein the change in the appearance comprises additional graphics forming a user interface that emerges from the graphic representation of the network-connected device.

23. The method of claim 15, wherein the change in the appearance comprises additional graphics that are suggestive of the received state the network-connected device.

24. The method of claim 15, wherein the graphic representation of the network-connected device comprises a pull-out tab configured to enable a command to be initiated and sent to the network-connected device.

25. The method of claim 15, wherein the state of the graphic representation of the network-connected device comprises a current operation carried out by the network-connected device.

26. The method of claim 15, further comprising enabling the generated graphic representation of the network-connected device to interact with another graphic representation of a network-connected device to carry out a function.
